(19) United States
(12) Patent Application Publication
(10) Pub. No.: US 2021/0399663 A1
(43) Pub. Date: Dec. 23, 2021

(54) APPARATUS AND METHOD FOR DETECTING MOTOR ROTOR POSITION

(71) Applicant: HOLTEK SEMICONDUCTOR INC., Hsinchu (TW)

(72) Inventors: Zu-Sheng HO, Hsinchu (TW); Kai-Jie YANG, Hsinchu (TW); Jia-En LIU, Hsinchu (TW)

(73) Assignee: HOLTEK SEMICONDUCTOR INC., Hsinchu (TW)

(21) Appl. No.: 17/075,221

(22) Filed: Oct. 20, 2020

(30) Foreign Application Priority Data
Jun. 19, 2020 (TW) 109120927

(51) Int. Cl. H02P 21/18; H02P 6/18; H02P 21/22; H02P 21/10; H02P 27/06

(52) U.S. Cl. CPC H02P 21/18; H02P 6/183; H02P 27/06; H02P 21/10; H02P 21/22

(57) ABSTRACT

An apparatus and a method for detecting a motor rotor position are provided. The method for detecting a motor rotor position includes: transmitting test current commands and preset angles to a field oriented control circuit before a motor rotor rotates, to enable the field oriented control circuit to generate feedback currents, determining current peaks of the feedback currents, and comparing the current peaks of the feedback currents, and when determining that a current peak of a feedback current with a largest current peak in the feedback currents is greater than a current peak of another feedback current, outputting, according to a largest current peak current command corresponding to the feedback current with the largest current peak, a preset angle corresponding to the largest current peak current command as an initial angle position of the motor rotor.

### CROSS-REFERENCE TO RELATED APPLICATION

This non-provisional application claims priority under 35 U.S.C. § 119(a) to Patent Application No. 109120927 filed in Taiwan, R.O.C. on Jun. 19, 2020, the entire contents of which are hereby incorporated by reference.

### BACKGROUND

### Technical Field

The present disclosure relates to an apparatus and a method for detecting a motor rotor position, and in particular, to an apparatus and a method for detecting a motor rotor initial angle position under a field oriented control (FOC) architecture.

### Related Art

Motors have been widely applied to electronic devices, such as robotic arms, semiconductor manufacturing & packaging machine, elevator, air conditioners, electric vehicles, scanners, printers, and compact disc read-only memory drive, etc. For the sake of controlling the motor to rotate normally, a conventional motor rotor detector usually includes a rotor position sensor, which used to detect an initial position of the motor rotor before motor regular operation. It can avoid occurrence of an unexpected running status during the startup of the motor.

However, using the aforementioned rotor position sensor increase the production costs. If we do not use the rotor position sensor during the startup, the motor may run in an unexpected status. Therefore, some different motor control technologies should develop to replace the rotor position sensor. However, in most motor control technologies, an additional circuit should be disposed. Consequently, it cannot effectively reduce the production costs. Moreover, it is difficult to adjust the additional circuit design versus different motors rotor types.

### SUMMARY

A method for detecting a motor rotor position including: transmits, before a motor rotate, a test command to a field oriented control circuit in a preset time interval, where the test command includes a test current command and a preset angle. Additionally, generates a feedback current according to the test command, acquires a current peak of the feedback current to form a current peak array, and calculates maximum of elements in the current peak array. Otherwise, selects one corresponding angle from the preset angle according to the maximum. Then generates the corresponding preset angle as an initial angle position of the motor rotor to control the motor regular operation.

In one embodiment, an apparatus for detecting a motor rotor position includes a field oriented control circuit and an initial position detection circuit. The field oriented control circuit receives a test current command and a preset angle in a preset time interval, and generates a feedback current according to the test current command and the preset angle. The initial position detection circuit transmits the test current command and the preset angle to the field oriented control circuit. The initial position detection circuit including a current generator, an angle generator, and a processing circuit. The current generator outputs the test current commands; the angle generator outputs the preset angle. Meanwhile, the processing circuit acquires a current peak of the feedback current to form a current peak array calculates a maximum of elements in the current peak array. On the other hand, selects one corresponding angle from the preset angle according to the maximum to form an initial angle position of the motor rotor, and transmits, before the motor rotates, the initial angle position to the field oriented control circuit to control the motor regular operation.

### BRIEF DESCRIPTION OF THE DRAWINGS

FIG. 1 is a functional block diagram of an embodiment of an apparatus for detecting a motor rotor position and a motor controlled by the apparatus for detecting a motor rotor position according to the present disclosure.

FIG. 2 is a flowchart of an embodiment of a method for detecting a motor rotor position to which a motor is applied according to the present disclosure.

FIG. 3A to FIG. 3D are waveform diagrams of an embodiment of a test current command, a preset angle, a feedback current, and an initial angle position in FIG. 1.

FIG. 4 is a flowchart of an embodiment of the step S02 in FIG. 2.

FIG. 5 is a circuit diagram of an embodiment of a driving circuit in FIG. 1.

FIG. 6 is a functional block diagram of an embodiment of an initial position detection circuit in FIG. 1.

### DETAILED DESCRIPTION

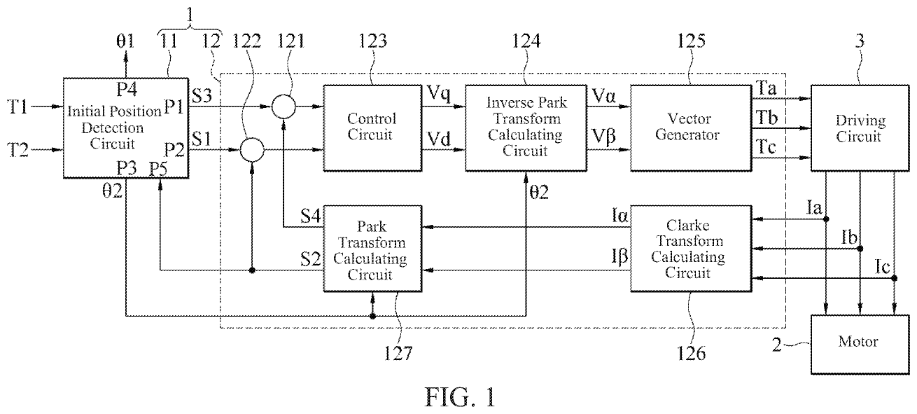

FIG. 1 is a functional block diagram of one embodiment of an apparatus 1 for detecting a motor rotor position and a motor 2 controlled by the apparatus for detecting a motor rotor position according to the present disclosure. Referring to FIG. 1, the apparatus 1 for detecting a motor rotor position includes an initial position detection circuit 11 and a field oriented control circuit 12. The apparatus 1, which is used for detecting a motor rotor position, controls the motor 2 to rotate by using a driving circuit 3. The motor 2 is applicable to field oriented control (FOC), and the apparatus 1 has the foregoing FOC function. In one embodiment, the motor 2 may be a brushless DC (BLDC) motor or a permanent-magnet synchronous motor (PMSM). The driving circuit 3 is designed by a manufacturer of the motor 2, and a function of the driving circuit 3 is to convert driving signal transmitted by the apparatus 1 to signal that can be read by the motor 2 and drive the motor 2 to rotate.

Please follow up the FIG. 1. The initial position detection circuit 11 is coupled to the field oriented control circuit 12, and the field oriented control circuit 12 is coupled to the motor 2. The field oriented control circuit 12 determines the direction of a torque controlling a rotor (not shown in FIG. 1) rotation in motor 2, or the direction of a magnetic field generated by a stator (not shown in FIG. 1). Before the motor 2 regular operation, the initial position detection circuit 11 generates all test commands in a preset time interval set by a user. Preferably, the preset time interval generally ranges from 5 ms to 15 ms. The test commands include a test current command (comprises a plurality of direct-axis test current commands S1 and a plurality of quadrature-axis test current commands S3) and a plurality of preset angles θ2. The direct-axis test current command S1 is transmitted from a port P2, and the quadrature-axis test current command S3 is transmitted from a port P1, and the preset angle θ2 is transmitted from a port P3. On the other hand, the three signals (the direct-axis test current command S1, the quadrature-axis test current command S3, and the preset angle θ2) have the same cycle.

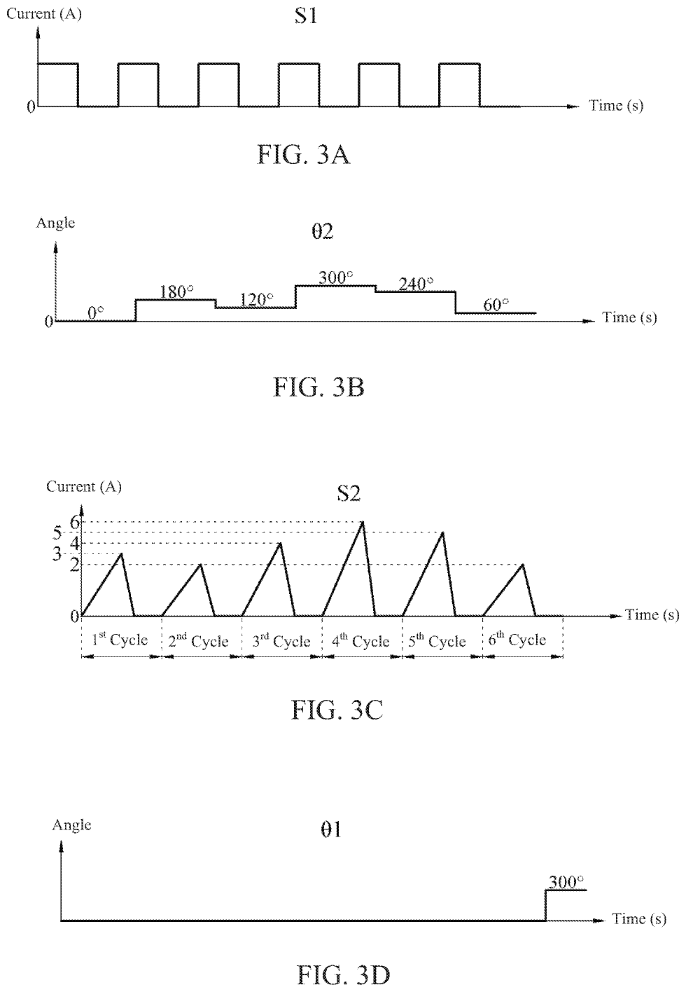

Please Refer to FIG. 3A-FIG. 3D next. The initial position detection circuit 11 generates six direct-axis test current commands S1 and six different preset angles θ2. In addition, in this embodiment, the quadrature-axis test current commands S3 are all 0 A (ampere). The initial position detection circuit 11 may transmit all test commands within 8 ms (the preset time interval). The six direct-axis test current commands S1 respectively occupy six cycle times (1^{st} cycle to 6^{th} cycle). The duration in all cycles could be 1.3 ms.

In addition, signals in the same cycle time have the same serial number. For example, a direct-axis test current command S1 in the 1^{st} cycle is named as “first direct-axis test current command” and a “corresponding” preset angle θ2 in the 1^{st} cycle is named as “first preset angle”. For the same reason, a direct-axis test current command S1 and a preset angle θ2 in a 2^{nd} cycle is named as “second direct-axis test current command” and “second preset angle” respectively. The signals in a 3^{rd}-6^{th} cycle have the same naming rule, too. In addition, the “corresponding” means the signals are generated or processed in the same cycle.

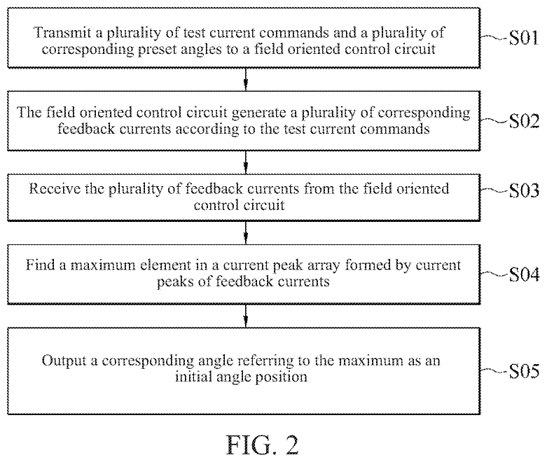

Please refer to FIG. 1-FIG. 3D next. FIG. 2 shows a flowchart regarding a method for detecting a motor rotor position, which is applied to the motor 2. The initial position detection circuit 11 transmits test commands to the field oriented control circuit 12 (step S01) in a preset time interval before the motor 2 regular rotation. Then the field oriented control circuit 12 receives the test commands and the preset angles in the preset time interval, and generates a feedback current S2 that can control the motor 2 to rotate (step S02), and the field oriented control circuit 12 generates a corresponding feedback current S2 on the basis of each direct-axis test current command S1. Therefore, the field oriented control circuit 12 generates a plurality of feedback currents S2 having different current peaks according to the every direct-axis test current commands S1, the every quadrature-axis test current command S3 and the every corresponding different preset angle θ2. By the way, be similar to quadrature-axis test current commands S3, the quadrature-axis feedback current S4 are quadrature-axis current in the rotor-based coordinate. Moreover, a response time for the field oriented control circuit 12 generating each feedback current S2 is 100 us which can be ignored. That is, the feedback current S2 and the direct-axis test current command S1 generated “simultaneously”.

After that, the initial position detection circuit 11 then receives the plurality of feedback currents S2 from the field oriented control circuit 12 (step S03). Next, the initial position detection circuit 11 acquires current peaks of all feedback currents S2 to form a current peak array, and finds the maximum element in the array (step S04). After that, the initial position detection circuit 11 selects, before the motor 2 regular operation, one corresponding angle from the plurality of preset angles θ2 referring to the maximum, and regarding the corresponding angle as an initial angle position θ1 (step S05) to drive the field oriented control circuit 12 to control the motor 2 regular operation. In addition, the turnaround time concerning generating the initial angle position θ1 by the initial position detection circuit 11 is usually from 2 to 8 us, which can be ignored. That is, the initial position detection circuit 11 calculates the initial angle position θ1 very quickly.

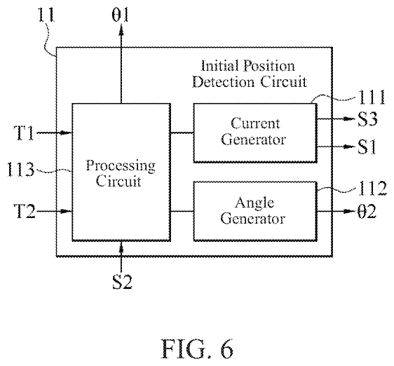

We detail the step S01-S05 in the following. Please refer to FIG. 1, FIG. 6 and FIG. 3A-FIG. 3D. The field oriented control circuit 12 generates six feedback currents S2 with different current peaks according to the six direct-axis test current commands S1 and the six preset angles θ2. After that, a processing circuit 113 in the initial position detection circuit 11 subsequently acquires the six feedback currents S2 (of which unit should be Ampere) to form a current peak array X={3, 2, 4, 6, 5, 2}, and finds the maximum element in the current peak array X is 6. Because the maximum “6” corresponding to a fourth feedback current which belongs to the 4^{th} cycle, the processing circuit 113 in the initial position detection circuit 11 determine a fourth preset angle (that is, 300 degrees) that is also in the 4^{th} cycle. Afterwards, the processing circuit 113 refers the fourth preset angle as the initial angle position θ1 and outputs the angle to perform that the field oriented control circuit 12 controlling the motor 2 which executing regular operation (regular rotating). The field oriented control circuit 12 also “knows” the initial angle position θ1 in the rotor-based coordinate is 300 degrees.

Therefore, the initial angle position θ1 of the rotor is detected first based on the FOC architecture before the motor 2 regular operation and none of current sampling resistors, amplifiers and DACs (digital to analog converters) may be additionally added to driving circuit 3 for detecting the initial angle position θ1 of the rotor in the present disclosure. Therefore, additional hardware costs could save. On the other hand, the designer can adjust test command so as to improve the accuracy of the initial angle position θ1 of the rotor and reduce the false rate of the initial angle position θ1 in the rotor and avoid an unexpected running status occurring during the startup of the motor 2.

In one embodiment, the direct-axis test current command S1 is constructed from current pulse signal and the initial position detection circuit 11 could set current values of the direct-axis test current command S1 and the quadrature-axis test current command S3 based on the type of the motor 2. On the other hand, the initial position detection circuit 11 could change a high-level signal T1 and a low-level signal T2 in the direct-axis test current command S1 for adjusting a duty cycle of the direct-axis test current command S1. We use FIG. 3A as an example. The initial position detection circuit 11 sets all six direct-axis test current commands S1 in 5 Amperes with BLDC motors, and all the six direct-axis test current commands S1 have the same high-level signal T1 and the low-level signal T2. Hence, the six direct-axis test current commands S1 have the same duty cycle.

Please return to FIG. 2. In step S01, the initial position detection circuit 11 could generate one direct-axis test current command S1 in each cycle, and the initial position detection circuit 11 could generate six direct-axis test current commands S1 and six preset angles θ2 in six cycle times. Namely, the “preset time interval” is the sum of the cycle times. After the preset time interval, the field oriented control circuit 12 outputs a corresponding feedback current S2 according to each direct-axis test current command S1 and the detection circuit 11 determines the initial angle position θ1 of the rotor.

In one embodiment, in consequence of improving the accuracy of the initial angle position θ1, we regulate that the difference between two preset angles θ2 transmitted by the initial position detection circuit 11 in two adjacent cycles is at least greater than or equal to a default. A designer can settle the default. The default could be greater than or equal to 1 degree, preferably 180 degrees. If the default is less than 1 degree, the adjacent two preset angles θ2 transmitted by the initial position detection circuit 11 is so closely. It also makes the adjacent corresponding feedback currents S2 so close due to residential magnetic (we called hysteresis lag). Hence, the initial position detection circuit 11 does not distinguish the maximum element in the current peak array and even judge wrong initial angle position θ1 in series. That is, the angular difference between two preset angles θ2 in a test command is smaller, the initial angle position θ1 misjudging is easier. We provide larger default to avoid misjudging the initial angle position θ1 of the rotor.

FIG. 3B illustrates one embodiment. We set six preset angles θ2 of a first preset angle to a sixth preset angle corresponding to the six direct-axis test current commands S1, and these preset angle are 0 degree, 180 degrees, 120 degrees, 300 degrees, 240 degrees, and 60 degrees in order. On the other hand, we can learn a difference between two preset angles θ2 transmitted in two adjacent cycles is at least greater than or equal to a default of 60 degrees from the figures. Besides, the default could be a “set”. For example, the default could be 180 degrees and 60 degrees. In one embodiment, an angular difference between the first preset angle and a second preset angle is 180 degrees as well as an angular difference between the second preset angle and a third preset angle is 60 degrees. An angular difference the third preset angle and a fourth preset angle is 180 degrees as well as an angular difference between the fourth preset angle and a fifth preset angle is 60 degrees. In the last, an angular difference between the fifth preset angle and the sixth preset angle is 180 degrees. As the mentioned above, a difference between every two preset angle θ2 generated according to different time should be large to the greatest extent so as to avoid a case that the initial position detection circuit 11 misjudges the initial angle position θ1 of the rotor.

Back to FIG. 1. Because the driving circuit 3 is essential for controlling the motor 2 to rotate, the driving circuit 3 must be coupled to both the field oriented control circuit 12 and the motor 2. The field oriented control circuit 12 includes a quadrature-axis current combining circuit 121, a direct-axis current combining circuit 122, a control circuit 123, an inverse Park transform calculating circuit 124, a vector generator 125, a Clarke transform calculating circuit 126 and a Park transform calculating circuit 127. All the quadrature-axis current combining circuit 121, the direct-axis current combining circuit 122, the inverse Park transform calculating circuit 124 and the Park transform calculating circuit 127 is coupled to the initial position detection circuit 11. All the control circuit 123, the inverse Park transform calculating circuit 124, and the vector generator 125 is coupled sequentially between the quadrature-axis current combining circuit 121 and the driving circuit 3. Besides, the control circuit 123, the inverse Park transform calculating circuit 124, and the vector generator 125 is coupled in series between the direct-axis current combining circuit 122 and the driving circuit 3. The Clarke transform calculating circuit 126 is coupled to the driving circuit 3 and the motor 2 in the same time. The Park transform calculating circuit 127 is coupled between the Clarke transform calculating circuit 126 and the quadrature-axis current combining circuit 121 in the same time. Meanwhile, The Park transform calculating circuit 127 is coupled between the Clarke transform calculating circuit 126 and the direct-axis current combining circuit 122. The initial position detection circuit 11 includes ports P1, P2, P3, and P4. The port P1 is coupled to the quadrature-axis current combining circuit 121, the port P2 is coupled to the direct-axis current combining circuit 122 and the port P3 is coupled to the Park transform calculating circuit 127 and the inverse Park transform calculating circuit 124.

Please reference the FIG. 1 to FIG. 4 in the following. In one embodiment, in step S01, a current value of a quadrature-axis test current command S3 that output via the port P1 in the initial position detection circuit 11 is 0 Ampere. Meanwhile, a direct-axis test current command S1 outputs to the field oriented control circuit 12 by the port P2 in the initial position detection circuit 11. On the other hand, the port P3 of the initial position detection circuit 11 outputs a plurality of preset angles θ2 to both the inverse Park transform calculating circuit 124 and the Park transform calculating circuit 127. Next, in the first procedures of the step S02 (that is, S021), the quadrature-axis current combining circuit 121 in the field oriented control circuit 12 receives the quadrature-axis test current command S3 from the port P1 and the six direct-axis test current commands S1 from the port P2. The port P1 and the port P2 within the initial position detection circuit 11.

Simultaneously, the quadrature-axis current combining circuit 121 receives a quadrature-axis feedback current S4 from the Park transform calculating circuit 127 (before the rotor of the motor 2 regular operation, a current value of the quadrature-axis feedback current S4 should be an initial value, and the initial value could be 0.) Then, the quadrature-axis current combining circuit 121 combines the quadrature-axis test current command S3 and the quadrature-axis feedback current S4 for outputting signal to control circuit 123. The step S021 has been finished. In addition, taking FIG. 3A to FIG. 3D as an example, in six cycles specified by a developer, the direct-axis current combining circuit 122 receives six direct-axis test current commands S1 from the port P2 in the initial position detection circuit 11. Furthermore, the direct-axis current combining circuit 122 receives a feedback current S2 that is a direct-axis feedback current from the Park transform calculating circuit 127 (before the rotor of the motor 2 regular operation, a current value of the feedback current S2 could be an initial value, and the initial value may be 0). The direct-axis current combining circuit 122 combines the direct-axis test current commands S1 and the feedback current S2 for output signal to control circuit 123.

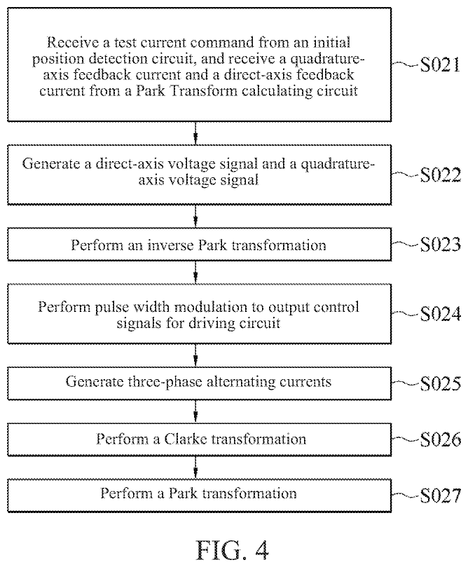

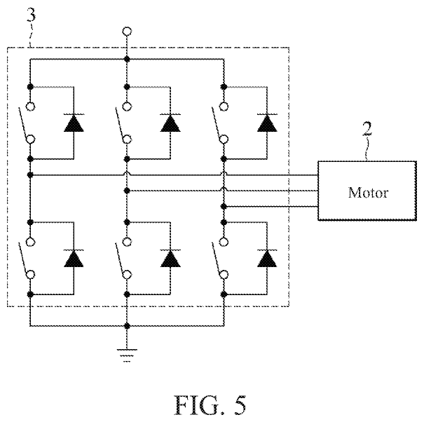

Please reference the FIG. 1, FIG. 4, and FIG. 5 in the following. In each six cycle, the control circuit 123 generates a direct-axis voltage signal Vd and a quadrature-axis voltage signal Vq that are correspondingly direct current signals based on both signal outputted by the quadrature-axis current combining circuit 121 and the direct-axis current combining circuit 122 (step S022). In each six cycle, the inverse Park transform calculating circuit 124 then performs formula 1.1 called an inverse Park transformation (step S023). The formula 1.1 uses the direct-axis voltage signal Vd, the quadrature-axis voltage signal Vq, and the six preset angles θ2. The entire signal is transmitted by the initial position detection circuit 11. The inverse Park transform calculating circuit 124 carries out two alternating voltage signals Vα and Vβ in the two-phase stationary coordinate axes in each cycle. After that, the vector generator 125 performs pulse width modulation (PWM) method on the alternating voltage signals Vα and Vβ in the vector space in each six cycles for controlling the driving circuit 3 (step S024). The PWM modulation method is performed by tuning up the duty cycle on Vα and Vβ. After the tuning, the Ta, Tb, and Tc signal is generating for controlling the driving circuit 3 (Ta, Tb, and Tc signal can be referred to as control signals for driving circuit 3). Because all Ta, Tb, and Tc are constructed form different duty cycles, we called the three signal is “in three phases”. The driving circuit 3 having the switches (which implemented by toggles) and shown in FIG. 5. All the Ta, Tb, and Tc signal used to control the switches conducting or break. After that, the driving circuit 3 will generate three-phase alternating currents Ia, Ib and Ic in three-phase stationary coordinate based on the Ta, Tb and Tc signal in each six cycles for controlling the motor to rotate (step S025).

$$[ \begin{matrix}V α \\ V β\end{matrix} ] = [ \begin{matrix}cos θ2 & - sin θ2 \\ sin θ2 & cos θ2\end{matrix} ] [ \begin{matrix}Vd \\ Vq\end{matrix} ] \qquad ( 1.1 )$$

When the rotor of the motor 2 rotates, the field oriented control circuit 12 acquires the three-phase alternating currents Ia, Ib, and Ic, and perform a formula 1.2 called Clarke transformation by using the Clarke transform calculating circuit 126 in each six cycles (step S026). The Clarke transform calculating circuit 126 can convert all the three-phase alternating currents Ia, Ib, and Ic into two alternating currents Iα and Iβ corresponding to the two-phase stationary coordinate axes. The Park transform calculating circuit 127 then performs Park transformation in each six cycles (step S027) to convert, based on a formula 1.3, the alternating currents Iα and Iβ into a quadrature-axis feedback current S4 and a feedback current S2 that correspond to synchronous rotating coordinate axes. Both the quadrature-axis feedback current S4 and a feedback current S2 are direct currents.

$$[ \begin{matrix}I α \\ I β\end{matrix} ] = [ \begin{matrix}1 & - 0.5 & - 0.5 \\ 0 & 0.866 & - 0.866\end{matrix} ] [ \begin{matrix}Ia \\ Ib \\ Ic\end{matrix} ] \qquad ( 1.2 )$$

$$[ \begin{matrix}Id \\ Iq\end{matrix} ] = [ \begin{matrix}cos θ2 & sin θ2 \\ - sin θ2 & cos θ2\end{matrix} ] [ \begin{matrix}I α \\ I β\end{matrix} ] \qquad ( 1.3 )$$

The initial angle position θ1 may then be transmitted to other components, and the other components may transmit all the initial angle position θ1, and a direct-axis input current command, and a quadrature-axis input current command which is required during running to the field oriented control circuit 12. It can enable the field oriented control circuit 12 to control the motor 2 regular operation. Furthermore, it can avoid malfunction when the motor 2 is in regular operation.

The numbers of the direct-axis test current command S1 strong relates the accuracy. As shown in FIG. 3A, if we set the number of the direct-axis test current commands to six, it represents that one circumference (a track of the rotor) is divided into six anchor points, and the angular position between two adjacent anchor points is 60 degrees. In other embodiments, the numbers of the direct-axis test current commands S1 may range from 2 to 360, optimizes from 2 to 12, and 6 is the best. For example, if the number of the direct-axis test current commands S1 is set to ten, it represents that one circumference (a track of the rotor) is divided into 10 anchor points, and the angular position between two adjacent anchor points is 36 degrees. It can generate more accurate initial angle position θ1. Designers may develop the initial angle position θ1, the numbers of the direct-axis test current commands S1 and the quantity of the corresponding preset angles θ2 based on a desirable accuracy. In one embodiment, the driving circuit 3 further includes an inverter (diodes) as FIG. 5 depicts. It can be learned from FIG. 5 that neither resistors nor amplifiers could be disposed additionally in the driving circuit 3 for sampling the three-phase alternating currents Ia, Ib, and Ic. Therefore, costs and circuit space for disposing additional hardware can reduce.

In one embodiment, referring to FIG. 1 and FIG. 6 together, the initial position detection circuit 11 further includes a current generator 111, an angle generator 112, and a processing circuit 113. The processing circuit 113 is coupled to both the current generator 111 and the angle generator 112. The processing circuit 113 could control, based on a high-level signal T1 and a low-level signal T2, the current generator 111 to output a plurality of direct-axis test current commands S1 in six cycles in a preset time interval. Meanwhile, the processing circuit 113 could also control the angle generator 112 to output a preset angle θ2 corresponding to each direct-axis test current command S1 in each cycle in the preset time interval. In addition, the processing circuit 113 may receive feedback currents S2 from the Park transform calculating circuit 127 and then find the largest current peak among the feedback current peaks in the preset time interval. Finally, the initial position detection circuit 11 outputs a corresponding initial angle position θ1. In one embodiment, the processing circuit 113 could construct by finite state machine (FSM) structure in order to realize the current generator 111, the angle generator 112, and output the initial angle position θ1. On the other hand, the control circuit 123 could be a direct-axis currents type closed-loop controller and a quadrature-axis currents type closed-loop controller. In one embodiment, the control circuit 123 could be a proportional-integral-differential (PID) controller.

In addition, the range in math in which both the initial angle position θ1 and the preset angle θ2 are located on a virtual vector space (the vector space is referred as a domain in math) jointly defined by the initial position detection circuit 11, the inverse Park transform calculating circuit 124, and the Park transform calculating circuit 127. Therefore, in this embodiment, users could let the initial angle position θ1 transmit to the inverse Park transform calculating circuit 124 to perform calculation when the motor 2 runs formally. In another embodiment, the user could connect the port P4 with an extra converting circuit (not shown in FIG. 1) for converting the virtual vector space into a real space(three-dimensional coordinated). It makes the user convenient to perform subsequent processing, ex. get the rotor position in the real space in time.

In one embodiment, both the initial position detection circuit 11 and the field oriented control circuit 12 could implement by a microcontroller (MCU) or another controller having a control and data computing capability. The designer may use an architecture disclosed by FIG. 1, FIG. 5, and FIG. 6 to construct a chip, or perform the control method disclosed by FIG. 2 to FIG. 4 into code and then burn the code into a platform provided by the manufacturer to form a program and an application on the platform. User can manipulate the application to obtain the initial position of the motor (rotor) in real time. Because an ordinary platform only be used to control a rotation speed of the motor. If user require learning the initial position of the motor, a hardware circuit would be additionally disposed on the ordinary platform. If the user intends to learn of the initial position by ordinary platform without disposing extra apparatus, he can utilize the application which had been formed by the control method disclosed by FIG. 2 to FIG. 4 in the apparatus 1. It is quite convenient.

To sum up, the initial position detection circuit may replace a general rotor position sensor and the initial position detection circuit may integrate with the field oriented control circuit to detect the initial angle position of the motor rotor. The designer does not need to adjust the field oriented control circuit structure. Additionally, when the apparatus for detecting a motor rotor position implements by using an MCU, the designer does not need to modify field oriented control program code executed by the field oriented control circuit.

In addition, the designer may flexibly adjust the number of the test current commands and values of the preset angles for reducing the occurrence of misjudging the initial angle position of the rotor, and no current sampling resistor and corresponding amplifier and digital to analog converter should be added to a bus wire within the motor. It can save additional hardware costs.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. A method for detecting a motor rotor position comprising:
transmitting, before a regular operation, a test command to a field oriented control circuit in a preset time interval, wherein the test command comprises a test current command and preset angles;
generating, by the field oriented control circuit, a feedback current according to the test command;
acquiring a current peak of the feedback current to form a current peak array, and finding maximum element in the current peak array;
selecting one corresponding angle from the preset angles referring to the maximum; and
regarding the corresponding preset angle as an initial angle position of the motor rotor to control the regular operation.

2. The method for detecting a motor rotor position according to claim 1, wherein the preset time interval comprises a plurality of cycles, and a difference between two preset angles during two adjacent cycles, which is greater than or equal to a default.

3. The method for detecting a motor rotor position according to claim 2, wherein the default is greater than or equal to 1 degree.

4. The method for detecting a motor rotor position according to claim 1, wherein the test current command comprises a direct-axis test current command and a quadrature-axis test current command, and the direct-axis test current command is a current pulse signal constructed from a high-level signal and a low-level signal.

5. The method for detecting a motor rotor position according to claim 1, further comprising an outputting the initial angle position to an inverse Park transform calculating circuit of the field oriented control circuit step after regarding the corresponding preset angle as an initial angle position to control the regular operation so as to calculate operation parameters.

6. An apparatus for detecting a motor rotor position comprising:
an initial position detection circuit is configured to transmit a test command to a field oriented control circuit and to get an initial angle position of a motor rotor based on a feedback current, wherein the test command comprises a test current command and preset angles; and
a field oriented control circuit is coupled to the initial position detection circuit and is configured to receive the test command from the initial position detection circuit in a preset time interval then to generate the feedback current according to the test command;
wherein the initial position detection circuit comprising:
a current generator is configured to output the test current command;
an angle generator is configured to output the preset angles; and
a processing circuit is configured to transmit signal to both the current generator and the angle generator, and to acquire a current peak of the feedback then forming the initial angle position.

7. The apparatus for detecting a motor rotor position according to claim 6, wherein the initial position detection circuit transmitting the test command in a plurality of cycles, and a difference between two preset angles transmitted during two adjacent cycles, which is greater than or equal to a default.

8. The apparatus for detecting a motor rotor position according to claim 7, wherein the default is greater than or equal to 1 degree.

9. The apparatus for detecting a motor rotor position according to claim 6, wherein the field oriented control circuit further comprising:
a direct-axis current combining circuit is coupled to the initial position detection circuit, and is configured to receive the test current command; and
a quadrature-axis current combining circuit is coupled to the initial position detection circuit;
wherein the test current command is a current pulse signal and is constructed from a high-level signal and a low-level signal.

10. The apparatus for detecting a motor rotor position according to claim 6, wherein the field oriented control circuit further comprising:
an inverse Park transform calculating circuit;
wherein the processing circuit transmitting the initial angle position to the inverse Park transform in order that calculating rotation parameters.
